(19) United States
(12) Patent Application Publication
(10) Pub. No.: US 2008/0042943 A1
(43) Pub. Date: Feb. 21, 2008

(54) METHOD AND APPARATUS FOR AVERAGED LUMINANCE AND UNIFORMITY CORRECTION IN AN AM-EL DISPLAY

(76) Inventor: Ronald S. Cok, Rochester, NY (US)

Correspondence Address: David Novais;Patent Legal Staff, Eastman Kodak Company, 343 State Street, Rochester, NY, 14650-2201, US

(21) Appl. No.: 11/769,097

(22) Filed: Jun. 27, 2007

Related U.S. Application Data
(63) Continuation-in-part of application No. 11/424,645, filed on Jun. 16, 2006.

(51) Int. Cl. G09G 3/30

(52) U.S. Cl. 345/77

(57) ABSTRACT

A method that corrects average luminance or luminance uniformity variations in an active-matrix EL display by determining a first offset voltage and a first gain relationship between the voltage and the current passing through one or more light-emitting elements. The light-emitting elements are driven with a corrected signal formed by employing the first offset voltage and gain relationship values to compute a linear correction for the light-emitting elements. An updated offset voltage is determined along with an updated gain relationship between the voltage and the current passing through the light-emitting elements. A signal is received, corrected, and employed to drive the one or more light-emitting elements in the display.

### CROSS-REFERENCE TO RELATED APPLICATIONS

This is a continuation-in-part of application Ser. No. 11/424,645, filed, 16 Jun. 2006, entitled “METHOD AND APPARATUS FOR AVERAGED LUMINANCE AND UNIFORMITY CORRECTION IN AN AMOLED DISPLAY,” by Ronald S. Cok.

### FIELD OF THE INVENTION

The present invention relates to active-matrix electroluminescent (EL) displays employing thin-film transistors and having a plurality of light-emitting elements and, more particularly, to methods and apparatus for correcting average luminance and luminance uniformity of the light-emitting elements in such displays, including displays employing amorphous silicon thin-film transistors.

### BACKGROUND OF THE INVENTION

Flat-panel display devices, for example plasma, liquid crystal and electroluminescent (EL) displays have been known for some years and are widely used in electronic devices to display information and images. EL display devices rely upon thin-film layers of materials coated upon a substrate, and include organic, inorganic and hybrid inorganic-organic light-emitting diodes (LEDs). The thin-film layers of materials can include, for example, organic materials, inorganic materials such as quantum dots, fused inorganic nano-particles, electrodes (e.g. comprising metal or metal oxide), conductors, and silicon or metal oxide electronic components as are known and taught in the LED art. Such devices employ both active-matrix and passive-matrix control schemes and can employ a plurality of light-emitting elements. The light-emitting elements are typically arranged in two-dimensional arrays with a row and a column address for each light-emitting element and having a data value associated with each light-emitting element to emit light at a brightness corresponding to the associated data value.

Active-matrix electroluminescent devices typically employ thin-film electronic components formed on the same substrate as the light-emitting elements thereof to control light emission from individual light-emitting elements thereof. Such thin-film electronic components are subject to manufacturing process variabilities that may cause such components to have variable performance. In particular, the voltage at which thin-film transistors turn on (“threshold voltage”) may vary. Low-temperature polysilicon (LTPS) devices have a short-range variability due to the variability in the silicon annealing process used to form such devices. Amorphous silicon devices typically have a long-range variability due to variabilities in the silicon deposition processes. Further, threshold voltage properties of such thin-film devices may change significantly with use over time, particularly for amorphous silicon devices. Typical large-format displays, e.g., employing hydrogenated amorphous silicon thin-film transistors (aSi-TFTs) to drive the pixels in such large-format displays. However, as described in “Threshold voltage instability of amorphous silicon thin-film transistors under constant current stress” by Jahinuzzaman et al in Applied Physics Letters 87, 023502 (2005), the aSi-TFTs exhibit a metastable shift in threshold voltage when subjected to prolonged gate bias. This shift is not significant in traditional display devices such as LCDs because the current required to switch the liquid crystals in LCD display is relatively small. However, for LED applications, much larger currents must be switched by the aSi-TFT circuits to drive the light-emitting materials to emit light. Thus, EL displays employing aSi-TFT circuits are expected to exhibit a significant voltage threshold shift as they are used. This voltage shift may result in decreased dynamic range and image artifacts. Moreover, the organic materials in OLED and hybrid EL devices also deteriorate in relation to the integrated current density passed through them over time so that their efficiency drops while their resistance to current increases.

One approach to avoiding the problem of voltage threshold shift in aSi-TFT circuits is to employ circuit designs whose performance is relatively constant in the presence of such voltage shifts. For example, US 2005/0269959 entitled “Pixel circuit, active matrix apparatus and display apparatus” describes a pixel circuit having a function of compensating for characteristic variation of an electro-optical element and threshold voltage variation of a transistor. The pixel circuit includes an electro-optical element, a holding capacitor, and five N-channel thin-film transistors including a sampling transistor, a drive transistor, a switching transistor, and first and second detection transistors. Alternative circuit designs employ current-mirror driving circuits or voltage to current conversion circuits that reduce susceptibility to transistor performance, e.g., US2005/0180083, US2005/0024352 and WO2006/012028. Other methods, such as taught in US20040032382, WO2005/015530, and WO2006/046196, employ photo-sensors in pixel-driving circuits and employ feedback control so that pixels emit a desired amount of light regardless of organic material or transistor performance. However, such designs typically require complex, larger and/or slower circuits than the two-transistor, single-capacitor circuits otherwise employed, thereby increasing costs and reducing the area on a display available for emitting light and decreasing the display lifetime.

Other methods rely upon reversing or slowing the threshold-voltage shift. For example, US2004/0001037 entitled “Organic light-emitting diode display” describes a technique to reduce the rate of increase in threshold voltage, i.e. degradation, of an amorphous silicon TFT driving an OLED. A first supply voltage is supplied to a drain of the TFT when a first control voltage is applied to a gate of the TFT to activate the TFT and drive the OLED. However, a second, lower supply voltage is supplied to the drain of the TFT when a second control voltage is applied to the gate of the TFT to deactivate the TFT and turn off the OLED, whereby a voltage differential between the drain and the source when the second control voltage is applied to the gate is substantially lower said first supply voltage. This reduces degradation of the TFT. However, such schemes typically require complex additional circuitry and timing signals, thereby reducing the area on a display available for emitting light and decreasing the display lifetime and cost.

Other methods for improving the performance of aSi-TFTs to reduce their voltage-threshold shift employ means for crystallizing the silicon, thereby improving the performance of the silicon and reducing the voltage-threshold shift. For example, US2006/0009017 entitled “Method of crystallizing semiconductor film and method of manufacturing display device” describes a method of uniformly crystallizing a semiconductor film through scanning with pulse lasers. However, such process steps are expensive.

Other techniques employ compensation to mitigate the effects of changes in the display device. For example, U.S. Pat. No. 6,995,519 describes an organic light emitting diode (OLED) display comprising an array of OLED display light-emitting elements, each OLED display light-emitting element having two terminals; a voltage-sensing circuit for each OLED display light-emitting element in the display array including a transistor in each circuit connected to one of the terminals of a corresponding OLED display light-emitting element for sensing the voltage across the OLED display light-emitting element to produce feedback signals representing the voltage across the OLED display light-emitting elements in the display array; and a controller responsive to the feedback signals for calculating a correction signal for each OLED display light-emitting element and applying the correction signal to data used to drive each OLED display light-emitting element to compensate for the changes in the output of each OLED display light-emitting element. However, this design also suffers from the need for additional circuitry in each active-matrix pixel.

US 2004/0150590 describes an OLED display comprising a plurality of light-emitting elements divided into two or more groups, the light emitting elements having an output that changes with time or use; a current measuring device for sensing the total current used by the display to produce a current signal; and a controller for simultaneously activating all of the light-emitting elements in a group and responsive to the current signal for calculating a correction signal for the light-emitting elements in the group and applying the correction signal to input image signals to produce corrected input image signals that compensate for the changes in the output of the light emitting elements of the group. While this technique is useful, in particular for globally compensating for behavior changes in the organic materials, it does not adequately address the problem of threshold voltage shift in active-matrix circuits.

In addition to problems relating to amorphous silicon thin-film transistors, EL display devices can suffer from a variety of defects that limit the quality of the displays. In particular, EL displays suffer from non-uniformities in the light-emitting elements. These non-uniformities can be attributed to both the light-emitting materials in the display and, for active-matrix displays, to variability in the thin-film transistors used to drive the light-emitting elements.

It is known in the prior art to measure the performance of each pixel in a display and then to correct for the performance of the pixel to provide a more uniform output across the display. U.S. Pat. No. 6,081,073 entitled “Matrix Display with Matched Solid-State Pixels” by Salam granted Jun. 27, 2000 describes a display matrix with a process and control means for reducing brightness variations in the pixels. This patent describes the use of a linear scaling method for each pixel based on a ratio between the brightness of the weakest pixel in the display and the brightness of each pixel. However, this approach will lead to an overall reduction in the dynamic range and brightness of the display and a reduction and variation in the bit depth at which the pixels can be operated. Moreover, such a compensation method will not address problems resulting from the aging of amorphous silicon thin-film drive transistors.

U.S. Pat. No. 6,473,065 entitled “Methods of improving display uniformity of organic light emitting displays by calibrating individual pixel” by Fan issued Oct. 29, 2002, describes methods of improving the display uniformity of an OLED. In order to improve the display uniformity of an OLED, the display characteristics of all-organic light-emitting elements are measured, and calibration parameters for each organic-light-emitting-element are obtained from the measured display characteristics of the corresponding organic light-emitting element. The calibration parameters of each organic light-emitting element are stored in a calibration memory. The technique uses a combination of look-up tables and calculation circuitry to implement uniformity correction. However, the described approaches require either a lookup table providing a complete characterization for each pixel, or extensive computational circuitry within a device controller. This is likely to be expensive and impractical in most applications. Moreover, such a compensation method will not address problems resulting from the aging of amorphous silicon thin-film drive transistors.

Copending, commonly assigned U.S. Ser. No. 11/093,115 describes a method for the correction of average brightness or brightness uniformity variations in OLED displays wherein the brightness of each light-emitting element is measured at two or more, but fewer than all possible, different input signal values. While brightness or luminance measurements may be practical in a manufacturing environment, and thus appropriate for initial display calibration, they may be problematic after the display is subsequently put into use and thus less practical for performance of aging compensation.

US2006/0007249 discloses a method for operating and individually controlling the luminance of each pixel in an emissive active-matrix display device including storing transformation between digital image gray level value and display drive signal that generates luminance from pixel corresponding to digital gray level value; identifying target gray level value for particular pixel; generating display drive signal corresponding to identified target gray level based on stored transformation and driving particular pixel with drive signal during first display frame; measuring parameter representative of actual measured luminance of particular pixel at a second time after the first time; determining difference between identified target luminance and actual measured luminance; modifying stored transformation for particular pixel based on determined difference; and storing and using modified transformation for generating display drive signal for particular pixel during frame time following first frame time.

WO 2005/057544 describes a video data signal correction system for video data signals addressing active matrix electroluminescent display devices wherein an updated electrical characteristic parameter X is calculated for each drive transistor by measuring actual current through a power line in comparison to expected current determined using a model and a previously stored parameter value, where subsequent video data signals are corrected in accordance with the calculated parameter X. Calculation of characteristic parameters based on assumed pre-determined performance relationships, however, may require consideration of many parameters having complex interactive relationships, and further may not accurately reflect actual device performance.

There is a need, therefore, for an improved method of correcting average luminance and luminance uniformity in an active-matrix elelctroluminescent display that overcomes these objections.

### SUMMARY OF THE INVENTION

In accordance with one embodiment, the invention is directed towards a method for the correction of average luminance or luminance uniformity variations in an active-matrix electroluminescent (EL) display, comprising:

a) providing an active-matrix EL display having thin-film transistors driving one or more light-emitting elements responsive to a multi-valued input signal for causing the light-emitting elements to emit light at a plurality of luminance levels;

b) determining at a first time a first offset voltage at which at least one of the one or more light-emitting elements will not conduct more than a pre-determined minimum current and a first gain relationship between the voltage and the current passing through the at least one of the one or more light-emitting elements at voltages above the first offset voltage;

c) receiving a signal for driving the one or more light-emitting elements after step b), correcting the signal by employing the first offset voltage and gain relationship values to compute a linear correction for at least one of the one or more light-emitting elements to form a corrected signal, and driving the active-matrix EL display with the corrected signal;

d) determining at a time after the first time an updated offset voltage at which at least one of the one or more light-emitting elements will not conduct more than a pre-determined minimum current and an updated gain relationship between the voltage and the current passing through the at least one of the one or more light-emitting elements at voltages above the updated offset voltage; and

e) receiving a signal for driving the one or more light-emitting elements after step d), correcting the signal by employing the updated offset voltage and gain relationship values to compute a linear correction for at least one of the one or more light-emitting elements to form an updated corrected signal, and driving the active-matrix EL display with the updated corrected signal.

### ADVANTAGES

In accordance with various embodiments, the present invention may provide the advantage of improved uniformity and lifetime in a display.

### BRIEF DESCRIPTION OF THE DRAWINGS

FIG. 1 is a flow diagram illustrating one embodiment of the present invention;

FIG. 2 is a flow diagram illustrating an alternative embodiment of the present invention;

FIG. 3 is a prior-art schematic diagram illustrating a LED in series with a driving transistor;

FIG. 4 is a graph illustrating the relationship between voltage and current over time;

FIG. 5 is a schematic diagram illustrating a circuit useful in the implementation of the present invention;

FIG. 6a is a graph illustrating the relationship between voltage and current over time;

FIG. 6b is a graph illustrating the relationship between voltage and current over time; and

FIG. 6c is a graph illustrating a multiple linear functional relationship between voltage and current.

### DETAILED DESCRIPTION OF THE INVENTION

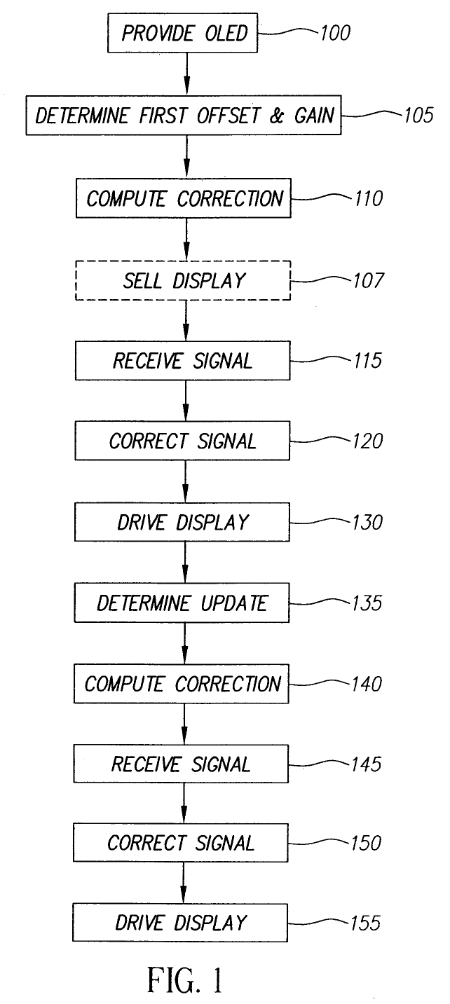

Referring to FIG. 1, a method for the correction of average luminance or luminance uniformity variations in an active-matrix electroluminescent (EL) display comprises the steps of providing 100 an active-matrix EL display having thin-film transistors driving one or more light-emitting elements responsive to a multi-valued input signal for causing the light-emitting elements to emit light at a plurality of brightness levels; determining 105 at a first time a first offset voltage at which at least one of the one or more light-emitting elements will not conduct more than a pre-determined minimum current and a first gain relationship between the voltage and the current passing through the at least one of the one or more light-emitting elements at voltages above the first offset voltage; receiving 115 a signal for driving the one or more light-emitting elements after determining the first offset voltage and first gain relationship, correcting the signal by employing the first offset voltage and gain relationship values to compute 110 a linear correction for at least one of the one or more light-emitting elements to form 120 a corrected signal, and driving 130 the active-matrix EL display with the corrected signal; determining 135 at a time after the first time an updated offset voltage at which at least one of the one or more light-emitting elements will not conduct more than a pre-determined minimum current and an updated gain relationship between the voltage and the current passing through the at least one of the one or more light-emitting elements at voltages above the updated offset voltage; and receiving 145 a signal for driving the one or more light-emitting elements after determining the updated offset voltage and gain relationship, correcting 150 the signal by employing the updated offset voltage and gain relationship values to compute 140 a linear correction for at least one of the one or more light-emitting elements to form an updated corrected signal, and driving 155 the active-matrix EL display with the updated corrected signal.

Since manufactured displays frequently have non-uniformities present immediately after they are made and before they are sold to customers, in one embodiment of the present invention the first offset voltage and first gain relationship are determined before the display is optionally sold 107 to a customer, and the updated offset voltage and updated gain relationship are determined 105 after the display is sold to a customer and put into use. In typical use by a customer, the display is viewed repeatedly over time and the steps 135-155 are repeated over time. The present invention has the advantage of employing simple measurements of actual EL device performance to compute signal corrections without requiring storage of past performance measurements or recording prior use, and/or determining differences between performance models and actual experience. Moreover, the simple linear corrections employed are inexpensive and readily employed using available integrated circuit technologies. Because actual performance is measured, other unanticipated environmental effects on EL performance may be accommodated (e.g., temperature effects or material degradation.)

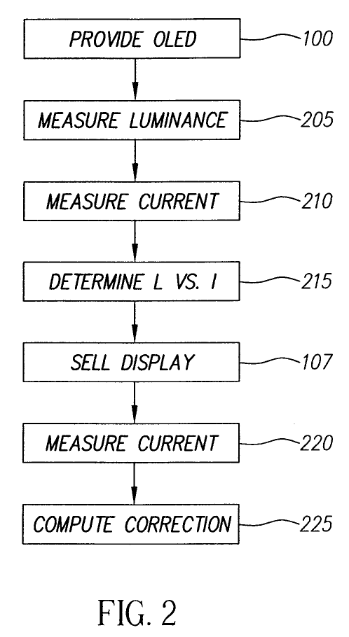

The first and updated offset and gain relationships may be determined by measuring the current used by one or more light-emitting element at a plurality of signal values corresponding to different luminance levels. Referring to FIG. 2, in another embodiment, the actual luminance of the at least one light-emitting element may also be measured 205 at a plurality of signal levels before the display is sold 107, along with measurement 210 of the current, and the measured current and luminance values may be employed to determine 215 a relationship between the luminance and the current usage of the display, and the determined relationship employed when computing 225 the linear correction for at least one of the one or more light-emitting elements when current measurements 220 are made after the display is sold.

Luminance measurements 205 may be made by providing a digital camera and computer that measures the luminance of one or more of the light-emitting elements of the display in response to signals provided to the display by a manufacturing process control computer. While luminance measurements may be practical in a manufacturing environment, they are problematic after the display is subsequently put into use. Accordingly, current used by the display is measured in the present invention instead of the actual luminance after sale and use of the display. Since luminance is directly related to current usage, such current measurements can be employed to determine light output uniformity. In a preferred embodiment of the present invention, the current and luminance are measured at manufacture to determine a relationship between the luminance and the current usage of the display and provide a baseline compensation level against which further current measurements done after the display is sold may be compared to form updated compensation parameters.

According to various embodiments of the present invention, the current response of the active-matrix light-emitting element may be simplified and represented by one or more linear functions. Corrections to signals may then be implemented by employing one or more adders and multipliers. The current conducted by each light-emitting element at two or more different input signal values may be measured and employed to estimate a maximum input signal value at which the light-emitting element will not conduct more than a predefined minimum current (the offset), and the rate at which the current conducted by the light-emitting element increases above the predefined minimum in response to increases in the value of the input signal (the gain relationship); and using the estimated maximum input signal value at which the light-emitting element will not conduct more than the predefined minimum current and the rate at which the current conducted by the light-emitting element increases above the predefined minimum brightness in response to increases in the value of the input signal to modify the input signal to a corrected input signal to correct the light output of the light-emitting elements. Finally, a corrected input signal for each pixel may be output to a display for viewing by an observer. In one embodiment, the input signal may be converted into a linear space before correcting if the input signal is not in an appropriate linear space for correction and output to a display. In such a case, the image may be converted back to the original space before display. Alternatively, the correction parameter may also be converted into the display space. Such conversions may be common to all light emitting elements, or to all light emitting elements of a particular color.

Although, in the most limited case, an EL device may employ a single light-emitter, in a preferred embodiment of the present invention, the EL display has more than one light-emitting element and the corrected input signal improves the luminance uniformity of the EL display. By repeating the updating steps, any aging of the EL display and loss in luminance over time may be reduced by employing the updated offset and gain relationships to correct input signals. If the EL device has a plurality of light-emitting elements, uniformity correction may be provided and applied individually or to all of the elements in a group by separately determining an offset and gain relationship for individual light-emitting elements or separate groups of elements. In other embodiments of the present invention, the EL display may be a color display comprising light-emitting elements of multiple colors and wherein the initial and updated measurements are done separately for each color of light-emitting element. EL displays having multiple color elements are known in the industry.

In general, there are several causes of performance degradation in active-matrix displays employing amorphous silicon thin-film transistors for driving the LED. First, as noted above, the voltage threshold of the amorphous silicon transistors generally increases over time so that a higher gate input voltage is necessary to achieve a similar current from the source to the drain of the transistor. In the case of OLED and hybrid EL devices, as the organic materials degrade over time and with repetitive use, the ohmic resistance through those degraded materials increases so that current and light output decrease at a constant voltage. Additionally, organic materials may lose efficiency with age, so that an increased amount of current is necessary to achieve a constant light output. In many cases, the aging and brightness of materials is related to the temperature of the LED device and materials when current passes through them.

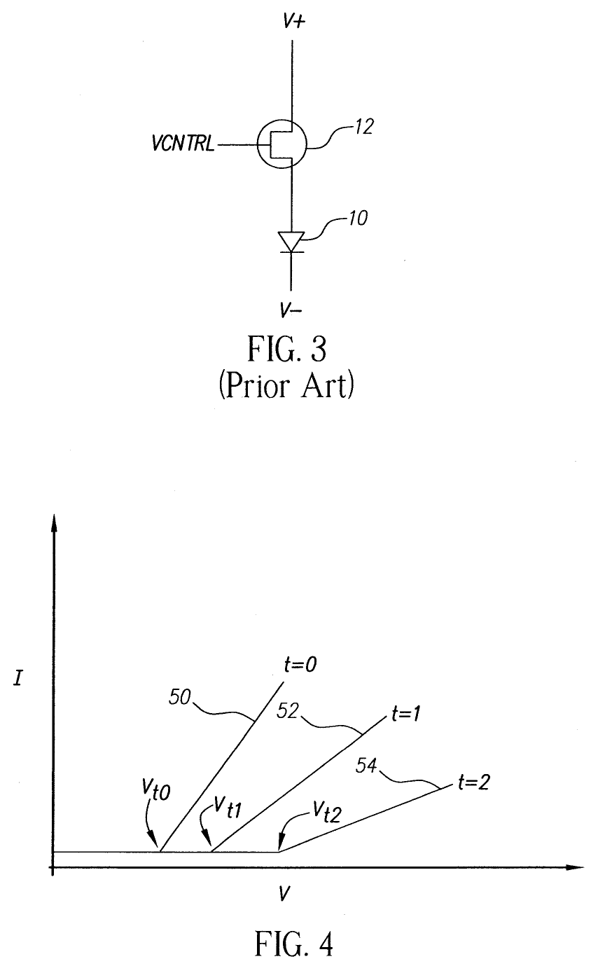

Referring to FIG. 3, a typical prior-art active-matrix EL drive circuit employs an LED (light-emitting diode) 10 in series with a driving transistor 12, connected either to the transistor drain or to the transistor source. The transistor source is connected to a power line (e.g. V+), the transistor gate to a controlling voltage (e.g. Vcntrl), and the transistor drain to the LED, while the other LED terminal is connected to a ground line (e.g. V−) or other voltage so that a voltage difference is provided across the series connection of the LED 10 and the driving transistor 12. As described above, as an active-matrix amorphous-silicon LED circuit is used and ages, the driving voltage must increase to accommodate the shift in threshold voltage. Second, because of the increased resistance of the LED, to achieve a constant current through the LED, either the driving voltage must increase (i.e. a higher gate voltage employed by the amorphous silicon transistor) for each signal code value or the voltage across the source and drain of the amorphous silicon transistor (i.e. the power provided to the circuit) must increase. Hence, the updated corrected signal may employ a gain correction to maintain a constant current through the light-emitting element for a given input signal. Third, because the aged LED materials may have reduced efficiency at a constant current, the current may need to be increased over time to achieve a similar light output so that the gain is further increased. Hence, the offset (i.e. the minimum driving voltage) and the gain (i.e. the relationship between voltage and current) of the active-matrix amorphous silicon circuit may be changed over time. Therefore, the updated correction signal may compensate for losses in efficiency of the light-emitting elements by employing a gain correction that is greater than the gain correction that would be necessary to match the current through the light-emitting element for a given input signal in accordance with the first gain relationship.

According to the present invention, to accommodate these changes in an active-matrix EL device, the offset (i.e. the voltage threshold) and the gain (i.e. the relationship between voltage and current) may be changed over time. An initial measure (for example, an optical or current measurement) may be employed to form an initial offset and gain relationship. As the EL device is used and ages, additional measurements (for example, current measurements) may be taken to establish new offset and gain values. Referring to FIG. 4, at time zero an initial voltage to current relationship 50 is illustrated with the offset point indicated by Vₜ₀. At time one later than time zero and after the EL device has been used and aged, a voltage-to-current relationship 52 is illustrated with the offset point indicated by Vₜ₁. At time two later than time one and after the EL device has been further used and aged, a voltage to current relationship 54 is illustrated with the offset point indicated by Vₜ₂.

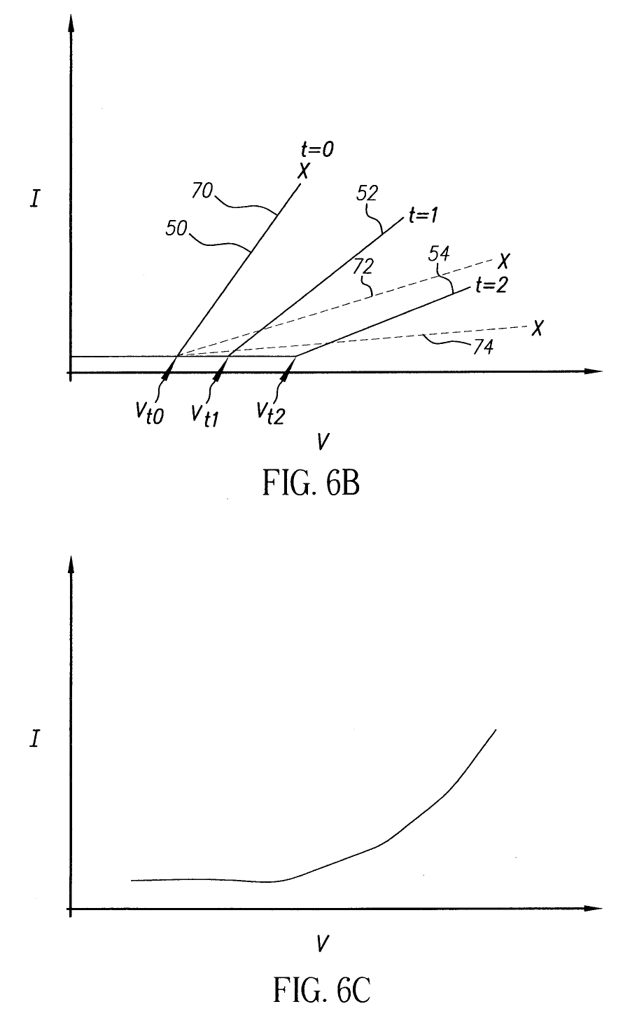

Because the active-matrix circuits may change their behavior as well as the LED materials, particularly in the case of organics, it is necessary to repeatedly obtain both an updated offset and gain relationship. Referring to FIG. 6a, the performance of the light-emitting element is illustrated with the continuous lines at various times by line 50 at time zero, line 52 at time one, and 54 at time two. If first and updated offset values were not obtained, the dashed lines 60, 62, and 64 corresponding to the times zero, one, and two as indicated might be employed to represent the behavior of the system (with an offset value of zero and an incorrect gain relationship computed based solely on current measured at a voltage X). If an initial first offset value was obtained but not updated, the behavior shown in FIG. 6b by dashed lines 70, 72, and 74 for times zero, one, and two might be employed. In either case, the corrections made employing such dashed lines would not be as accurate as those obtained with lines 50, 52, and 54.

Particularly in the case of OLED and hybrid EL devices, the materials typically not only increase their resistance as they age but become less efficient. In these cases, in order to maintain a constant luminance in response to a driving voltage (corresponding to a code value), it may be necessary to increase the current through the LED beyond the original current employed for the first correction. Because the change in offset and the change in resistance and the change in efficiency all move together in response to aging of the LED device (both the LED and the amorphous silicon driving transistor), it is possible to estimate each of them by measuring any one of the elements. For example, in one embodiment, the increase in the gain correction may be based on a change in offset voltage between the first and updated measurements. Alternatively, in another embodiment of the present invention, the increase in the gain correction may be based on a change in gain relationship between the first and updated measurements. The light output efficiency change may be measured by providing a constant current and measuring the light output. However, as noted above, this is difficult to do in the field and it may be preferred to measure the offset or the gain, for example by measuring the current usage in response to a variety of code values corresponding to gate voltage levels. The method of the present invention may then be repeated over time as the EL display is used to maintain uniformity and brightness.

The offset at which the EL device begins to conduct current above a minimum current (and correspondingly emit substantial light above a minimum level) and the gain relationship, representing the relationship between current through the LED (and corresponding luminance) and the voltage (represented by an analog code value) applied to the gate of the controlling drive transistor may be directly measured by sweeping the transistor drive voltage (e.g. from 0 to 255 for an eight-bit system) from a low to a high voltage or from a high to a low voltage and measuring the current used (or light output) at each value. The values may also be measured in a random order. However, such techniques can be relatively slow, particularly when applied to every light-emitting element in the EL device, and may use a significant amount of memory.

In an alternative embodiment of the present invention, fewer than every code value is applied to the LED circuit to determine the correction necessary. In a first alternative, values are selected to vary from a low value (e.g. code value 0), to a higher value at which substantial current is employed to emit light. This value or one slightly less may be considered the offset value. In a second phase, one or more additional values greater than the offset is measured and the relationship between the code value and light output or current used extrapolated, for example by using one or more linear fits to the points measured. In a minimum case, only one additional value is needed to provide a linear fit. In this minimum case, it may be preferred to use a code value significantly larger than the offset to reduce measurement error, for example by using the largest value available or a value midway between the largest value available and the offset.

In a second alternative, values may be selected to vary from a high value (e.g. code value 255 for an eight-bit system) to a lower value. In this embodiment, a first high value may be tested and then a second value lower than the high value but higher than the expected offset value, for example a value mid-way between the high value and the expected offset value. This second value (and any other selected for measurement) may be employed to form a gain relationship. This relationship may predict a zero light output code value (as shown by the gain portions of the lines in FIG. 4) at an offset value. In this way, a gain and offset may be determined with only two measurements.

According to an embodiment of the present invention, the updated offset voltage and gain relationship may be determined by measuring the current through at least one of the one or more light-emitting elements at only two signal values that result in two current values above the pre-determined minimum current, and the updated gain relationship may be a single linear function. Alternatively, additional measurements may be employed to reduce the likelihood of error by averaging measured values for more-than two measurements. In alternative embodiments of the present invention, if a linearizing conversion is not readily available, or is too costly or inaccurate, offsets and gains corresponding to a plurality of linear line segments (FIG. 6c) may be employed to more closely approximate the actual performance of the light-emitting element. Each consecutive pair of points may be used to calculate a different gain and offset value. These gain and offset values may be stored in the memory as described above. However, since they are range dependent (the appropriate offset and gain values depend on the data signal value), at least a portion of the input data signal must also be applied to the memory. Applicants have determined that, even in the worst cases, only a few different sets of correction values need be employed to provide adequate accuracy, hence only the most significant bits of a digital input data signal typically would need to be applied to the memory. For example, four different correction values may be employed over an 8-bit range: a first gain and offset value for the signal values ranging from 0-63, a second gain and offset value for the signal values ranging from 64-127, a third gain and offset value for the signal values ranging from 128-191, and a fourth gain and offset value for the signal values ranging from 192-255. In this example, only the two most significant bits are applied to the memory and an increase in memory size of a factor of four is required to store the additional information.

By employing only the gain relationship and offset values, a correction for every light-emitting element at every signal value of may be formed, stored in a small amount of storage (for example a non-volatile memory organized as a lookup table), and computed (for example by using an adder an multiplier) relatively easily. Such operations may also be employed for light-emitting elements having different colors.

It may also be useful to provide a greater number of bits to the corrected value than to the original input value, so as to reduce the likelihood of contouring in the output image. The number of bits used to store the corrections for each light-emitting element may be reduced (and the cost of the storage similarly reduced) by employing fewer bits than the input signal. For example, for an eight-bit input signal, a three-bit offset value and a five-bit gain value may be employed. It is also possible to use various compression schemes to reduce the storage requirements of the correction values, for example, by storing the values as a difference from a mean value and/or the rate at which the current increases above the predefined minimum in response to increases in the value of the input signal is stored as a difference from a mean value.

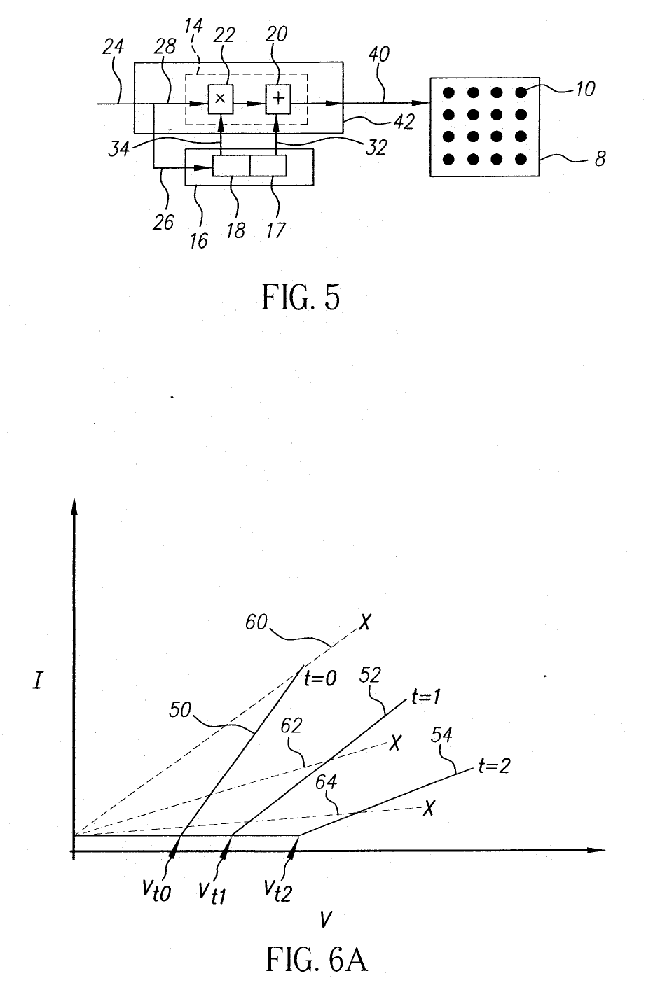

Referring to FIG. 5, a system useful for the implementation of the present invention is described. Active-matrix EL display 8 comprises thin-film transistors driving one or more light-emitting elements 10 responsive to a multi-valued input signal for causing the light-emitting elements to emit light at a plurality of brightness levels. Controller 42 comprises digital circuitry 14 including a memory 16 having offset values 17 with a first bit depth and gain values 18 with a second bit depth. The digital circuitry includes an adder 20 and multiplier 22. Controller 42 provides means for (i) accessing a pre-determined first offset voltage at which at least one of the one or more light-emitting elements will not conduct more than a pre-determined minimum current and a pre-determined first gain relationship between the voltage and the current passing through the at least one of the one or more light-emitting elements at voltages above the first offset voltage; (ii) receiving a signal for driving the one or more light-emitting elements, correcting the signal by employing the first offset voltage and gain relationship values to compute a linear correction for at least one of the one or more light-emitting elements to form a corrected signal, and driving the active-matrix EL display with the corrected signal; (iii) determining an updated offset voltage at which at least one of the one or more light-emitting elements will not conduct more than a pre-determined minimum current and an updated gain relationship between the voltage and the current passing through the at least one of the one or more light-emitting elements at voltages above the updated offset voltage; and (iv) receiving a signal for driving the one or more light-emitting elements, correcting the signal by employing the updated offset voltage and gain relationship values to compute a linear correction for at least one of the one or more light-emitting elements to form an updated corrected signal, and driving the active-matrix EL display with the updated corrected signal. The thin-film transistors of the active-matrix EL display may comprise amorphous silicon thin-film transistors. Suitable controllers, adders, multipliers, and memories for use in the invention are known in the digital arts.

In operation, an input signal 24 having an address value 26 and a data value 28 are input by the controller 42. The address value 26 is applied to the memory 16 to obtain an offset value 32 and gain value 34. The data value 28 is multiplied by the gain value 34 by the multiplier 22, and offset value 32 is added to the result by the adder 20 to form a corrected output value 40, which is then applied together with suitable timing and control signals supplied by the controller 42 to drive the display 8.

In an alternative embodiment, the maximum input signal value at which the light-emitting element will not conduct more than a predetermined minimum current (and correspondingly will not emit more than a predefined minimum luminance) is stored as a difference from a mean value and/or the rate at which the current conducted by the light-emitting element increases above the predefined minimum in response to increases in the value of the input signal is stored as a difference from a mean value. This may reduce the storage requirements of the correction values. The mean values may be stored in a controller, at another location in the memory, or in a driver circuit. In yet another embodiment, an indicator bit may be employed with the correction signals for each pixel to indicate when a correction is out of range. Out-of-range pixel corrections may be stored elsewhere in the memory, controller, or driving circuit.

In one embodiment, the compensation values are stored in a memory 16 packaged with an associated display device, to enable efficient packaging, shipment, and interconnection. Such a package can include a memory affixed to the display or to a connector fastened to the display and possibly sharing some of the connections of the connector.

According to a further embodiment of the present invention, the EL display 8 may be a color display with color pixels comprising, for example, red, green, and blue subpixels. For such a color display, a set of offset and gain values may be calculated for each sub-pixel, stored in a memory, and employed to correct an input signal, as described above. In order to minimize cost and size, a single integrated circuit memory having 32 bits (four bytes) of storage at each address location may be employed to provide 32 bits of correction information for each pixel. This storage may be divided in a variety of ways between the offset and gain values for each sub-pixel. For example, four bits may be employed for storing each of the red and blue offset values, six bits may be employed for storing each of the red and blue gain values, five bits may be employed for storing the green offset value and 7 bits for the green gain value. Since the human eye is most sensitive to green, additional information may be provided for the green channel. Alternatively, ten bits (four for offset and six for gain) may be provided for every color channel and the remaining two bits employed for other information. In a four-color pixel system (e.g. red, green, blue, and white), eight bits may be employed for each sub-pixel, for example with three bits of offset information and five bits of gain information. Alternatively, a larger memory having eight bits for each offset and gain value (6 bytes per pixel location) may be employed. This embodiment of the present invention may employ a lookup table of only 60,000 bytes for a 100-by-100 element display. A variety of memories having different numbers of bits per memory address are available commercially. In particular, memories with 8 bits or 32 bits per address location are known. In a further embodiment of the present invention, the corrections for each light-emitting element of a color in a color display may be adjusted to control the white point of the display.

According to an alternative embodiment of the present invention, the correction of the input data signal may be enhanced by first converting the input signal to a linear space in which the current conducted by a light emitting element is linearly related to an increase in data input signal value, if it is not already in such a space. This conversion may be common to all light-emitting elements, common to all light emitting elements of a common color, or individualized for each light-emitting element. Such conversions may be complex, since the relationship between signal value and current may be likewise complex, especially for a defective light-emitting element. If, for example, three values are measured, rather than averaging the values to form a poor linear approximation of the performance of the light emitters, the three values can be fit to an equation that is then used to create a conversion to linearize the relationship between signal value and current. The conversion can be done either with a computing circuit or a lookup table. The curve may not be monotonic and may have a complex shape, since the light emitter itself may be dysfunctional. Hence, a conversion of the input signal may be necessary to enable good results.

If the EL display is a color display comprising light-emitting elements of multiple colors, separate conversions may be made for input signals for each color of light-emitting element thereby enabling independent corrections for each of the color planes in the EL display.

It is generally desirable to drive a display employing a range of input signal values from a minimum luminance to a maximum luminance for an application. For example, in a digital camera display, a luminance range from 0 cd/m² to 200 cd/m² may be desired. It is also desirable to provide a smooth gray scale between the minimum and maximum luminance values. This may be achieved by mapping the input signal from its minimum value (typically zero) to its maximum value (typically 255 for an 8-bit system). Hence, the predefined minimum current selected to determine the offset voltage at which the light-emitting elements will not conduct more than a pre-determined minimum current will preferably be defined to correspond to the maximum current still resulting in a luminance of zero cd/m² and an input code value of zero.

Once the input signal values are converted into a linear space, the offset and gain values can be employed to cause each pixel in a display to output the same amount of light by correcting the signal used to drive the display to provide a known output. For example, if it is desired to uniformly emit light over a range of luminance from 0 cd/m² to 200 cd/m² employing a signal from 0 to 255 (8 bits), and a pixel has an offset voltage corresponding to a code value of 10 and a gain corresponding to 0.7 cd/bit, the signal must be multiplied by 1.12 and offset by 10 to provide the desired output. Of course, a limited number of bits in the offset and gain values and the circuitry will limit the precision and accuracy of the result. Generally, the more bits available, the more accurate will be the result.

In the case of using only two current measurements, the gain value may be simply estimated by finding the slope of the line formed by the two measurements. The offset value may be estimated by finding the input signal value at which the current equals a predetermined minimum current (e.g., in a simple case where the line crosses the input signal value axis). It is preferred to make the measurements of current at well-separated data input signal values. Since any measurement has an inherent error, the estimation of the gain and offset values may be more accurate if the values are not close together. Multiple measurements may be made to improve accuracy by providing more data points to fit a line. A variety of algorithms for fitting data may be employed as known in the numerical analysis art.

In an alternative embodiment of the present invention, a simplified correction mechanism may be employed to further reduce the complexity and size of the correction hardware. Applicant has determined that a large number of significant non-uniformity problems are associated with rows and columns of light-emitting elements. This is attributable to the manufacturing process. Therefore, it is possible to reduce the memory size by grouping pixels and using common correction factors for each group. For example, since pixel addressing schemes typically uses an x,y address, rather than supplying an individual correction factor for every light-emitting element, correction factors for rows or columns might be employed. If all of the pixels in one dimension (for example, a row) have common correction factors a single set of correction factors may be employed for the entire group (for example, a row). In the limit, a single set of values may be employed for all of the pixels in the display. In these situations, the address range is much smaller and the memory needed is correspondingly decreased.

Computing circuitry for integer multiplications and additions using fractions are readily accomplished using conventional digital circuitry known in the art. Likewise analog solutions, for example employing operational amplifiers, are known in the art. Algebraic computations for lines are well known and employ, for example, equations of the form y=mx+b, where m represents the slope of the equation and the gain in the system, and (y−b)/m the offset when y equals the predetermined minimum current. The conversion may be accomplished by multiplying the input signal value by the reciprocal of the slope (1/m) and adding the offset ((y−b)/m).

For example, a light-emitting element may output 4 cd/m² when driven at a signal value of 6 and may output 16 cd/m² when driven with a signal value of 12. In this example, the performance of the light emitting element in a linear space may be characterized as L=2*V−8, L,V>=0, where L is the light output in cd/m² and V is the value of the driving signal. The gain is then 2 and the offset is 4, that is: corrected signal value=(input signal value)/gain+offset (in this example corrected signal value=(input signal value)/2+4).

Other functions can be mapped similarly. If the offset value is negative (that is the output of a light emitting element cannot be turned off), an offset of zero may be employed for the defective light-emitting element. Alternatively, it may be desirable to map all light-emitting elements to match the performance of the defective light emitting elements. The multiplication value may be either greater or less than one. If a multi-segment correction is employed, the gain and offset for each segment should be calculated and employed for input signals in the range corresponding to the segment.

Means to measure the luminance of each light-emitting element in a display are known and described, for example, in the references provided above. In a particular embodiment, systems and methods as described in US 2005/0264149 may be employed, the disclosure of which is incorporated by reference herein.

The display requirements may be employed to improve manufacturing yields by correcting the uniformity of specific light-emitting elements or only partially correcting the uniformity of the light-emitting elements. Some applications can tolerate a number of non-uniform light-emitting elements. These light-emitting elements may be chosen to be more or less noticeable to a user depending on the application and may remain uncorrected, or only partially corrected, thereby allowing the maximum combined correction factor to remain under the limit described above. For example, if a certain number of bad light-emitting elements were acceptable, the remainder may be corrected as described in the present invention and the display made acceptable. In a less extreme case, bad light-emitting elements may be partially corrected so as to meet the lifetime requirement of the display application and partially correcting the uniformity of the display. Hence, the correction factors may be chosen to exclude light-emitting elements, or only partially correct light-emitting elements, that fall outside of a correctable range. This range may be application dependent. There are a variety of ways in which light-emitting elements may be excluded from correction. For example, a minimum or maximum threshold may be provided outside of which no light-emitting elements are to be corrected.

In a preferred embodiment, the present invention is employed in a flat-panel OLED device composed of small molecule or polymeric OLEDs as disclosed in but not limited to U.S. Pat. No. 4,769,292, issued Sep. 6, 1988 to Tang et al., and U.S. Pat. No. 5,061,569, issued Oct. 29, 1991 to VanSlyke et al. In another preferred embodiment, the present invention is employed in a flat panel inorganic LED device containing quantum dots as disclosed in, but not limited to U.S. Patent Application Publication No, 2007/0057263 entitled “Quantum dot light emitting layer” and pending U.S. application Ser. No. 11/683,479, by Kahen, which are both hereby incorporated by reference in their entirety. Many combinations and variations of organic, inorganic and hybrid light-emitting displays can be used to fabricate such a device, including both active-matrix LED displays having either a top- or bottom-emitter architecture.

The invention has been described in detail with particular reference to certain preferred embodiments thereof, but it will be understood that variations and modifications can be effected within the spirit and scope of the invention.

### PARTS LIST

8 display
10 light-emitting element
12 thin-film amorphous silicon transistor
14 digital circuit
16 memory
17 offset memory
18 gain memory
20 adder
22 multiplier
24 input signal
26 address
28 data
32 offset value
34 gain value
40 compensated signal
42 controller
50 voltage to current relationship at initial time
52 voltage to current relationship at time one
54 voltage to current relationship at time two
60 presumed voltage to current relationship at initial time
62 presumed voltage to current relationship at time one
64 presumed voltage to current relationship at time two
70 presumed voltage to current relationship at initial time
72 presumed voltage to current relationship at time one
74 presumed voltage to current relationship at time two
100 provide EL step
105 determine offset and gain relationship step
107 sell display step
110 compute correction step
115 receive signal step
120 correct signal step
130 drive display step
135 determine update step
140 compute correction step
145 receive signal step
150 correct signal step
155 drive display step
205 measure luminance step
210 measure current step
215 determine current-luminance relationship step
220 measure current step
225 compute correction step

1. A method for the correction of average luminance or luminance uniformity variations in an active-matrix electroluminescent (EL) display, comprising:
a) providing an active-matrix EL display having thin-film transistors driving one or more light-emitting elements responsive to a multi-valued input signal for causing the light-emitting elements to emit light at a plurality of luminance levels;
b) determining at a first time a first offset voltage at which at least one of the one or more light-emitting elements will not conduct more than a pre-determined minimum current and a first gain relationship between the voltage and the current passing through the at least one of the one or more light-emitting elements at voltages above the first offset voltage;
c) receiving a signal for driving the one or more light-emitting elements after step b), correcting the signal by employing the first offset voltage and gain relationship values to compute a linear correction for at least one of the one or more light-emitting elements to form a corrected signal, and driving the active-matrix EL display with the corrected signal;
d) determining at a time after the first time an updated offset voltage at which at least one of the one or more light-emitting elements will not conduct more than a pre-determined minimum current and an updated gain relationship between the voltage and the current passing through the at least one of the one or more light-emitting elements at voltages above the updated offset voltage; and
e) receiving a signal for driving the one or more light-emitting elements after step d), correcting the signal by employing the updated offset voltage and gain relationship values to compute a linear correction for at least one of the one or more light-emitting elements to form an updated corrected signal, and driving the active-matrix EL display with the updated corrected signal.

2. The method of claim 1, wherein the first offset voltage and first gain relationship are determined before the EL display is sold to a customer, and the updated offset voltage and updated gain relationship are determined after the display is sold to a customer and put into use.

3. The method of claim 1, wherein steps e) and d) are repeated over time.

4. The method of claim 1, wherein the first and updated voltage offsets and gain relationships are determined by measuring the current used by one or more light-emitting element at a plurality of luminance levels.

5. The method of claim 4, further comprising measuring the luminance of the at least one light-emitting element at a plurality of luminance levels before the display is sold, and wherein the measured current and luminance values are employed to determine a relationship between the luminance and the current usage of the display, and the determined relationship is employed when computing the linear correction for at least one of the one or more light-emitting elements employed to form the updated corrected signal.

6. The method of claim 1, wherein the thin-film transistors of the active-matrix EL display comprise amorphous silicon thin-film transistors.

7. The method of claim 1, wherein the signal correction is performed with an adder and/or a multiplier.

8. The method of claim 1, wherein the EL display has more than one light-emitting element and the corrected signal improves the luminance uniformity of the EL display.

9. The method of claim 1, wherein the EL display ages over time and the updated corrected signal compensates for changes in EL display luminance over time.

10. The method of claim 1, wherein the EL display is a color display comprising light-emitting elements of multiple colors, and wherein first and updated voltage offsets and gain relationships are determined separately for each color of light-emitting element.

11. The method of claim 1, wherein the updated corrected signal employs a gain correction to maintain a constant current through the light-emitting element for a given input signal.

12. The method of claim 1, wherein the updated correction signal compensates for losses in efficiency of the light-emitting elements by employing a gain correction that is greater than the gain correction that would be necessary to match the current through the light-emitting element for a given input signal in accordance with the first gain relationship.

13. The method of claim 12, wherein the increase in the gain correction is based on a change in offset voltage between the first and updated measurements.

14. The method of claim 12, wherein the increase in the gain correction is based on a change in gain relationship between the first and updated measurements.

15. The method of claim 1, wherein the updated offset voltage and gain relationship are determined by measuring the current through at least one of the one or more light-emitting elements at only two signal values that result in two current values above the pre-determined minimum current, and the updated gain relationship is a single linear function.

16. The method of claim 1, wherein the updated offset voltage and gain relationship are determined by measuring the current through at least one of the one or more light-emitting elements at more than two signal values that result in current values above the pre-determined minimum current, and the measurements are combined to form an updated gain relationship comprising a plurality of linear functions.

17. An active-matrix EL display, comprising:
a) an active-matrix EL display having thin-film transistors driving one or more light-emitting elements responsive to a multi-valued input signal for causing the light-emitting elements to emit light at a plurality of brightness levels; and
b) a controller for (i) accessing a pre-determined first offset voltage at which at least one of the one or more light-emitting elements will not conduct more than a pre-determined minimum current and a pre-determined first gain relationship between the voltage and the current passing through the at least one of the one or more light-emitting elements at voltages above the first offset voltage; (ii) receiving a signal for driving the one or more light-emitting elements, correcting the signal by employing the first offset voltage and gain relationship values to compute a linear correction for at least one of the one or more light-emitting elements to form a corrected signal, and driving the active-matrix EL display with the corrected signal; (iii) determining an updated offset voltage at which at least one of the one or more light-emitting elements will not conduct more than a pre-determined minimum current and an updated gain relationship between the voltage and the current passing through the at least one of the one or more light-emitting elements at voltages above the updated offset voltage; and (iv) receiving a signal for driving the one or more light-emitting elements, correcting the signal by employing the updated offset voltage and gain relationship values to compute a linear correction for at least one of the one or more light-emitting elements to form an updated corrected signal, and driving the active-matrix EL display with the updated corrected signal.

18. The EL display of claim 17, wherein the thin-film transistors comprise amorphous silicon thin-film transistors.

19. The EL display of claim 17, wherein the EL display comprises light-emitting quantum dots.

20. The EL display of claim 17, wherein the EL display comprises an OLED.
